(19) United States
(12) Patent Application Publication
(10) Pub. No.: US 2002/0122442 A1
(43) Pub. Date: Sep. 5, 2002

(54) Communication network, path setting method and node apparatus used therefor

(76) Inventor: Yoshihiko Suemura, Tokyo (JP)

Correspondence Address: DICKSTEIN SHAPIRO MORIN & OSHINSKY LLP, 41st Floor, 1177 Avenue of the Americas, New York, NY, 10036-2714, US

(21) Appl. No.: 10/084,325

(22) Filed: Feb. 28, 2002

(30) Foreign Application Priority Data
Mar. 2, 2001 (JP) 057578/2001

(51) Int. Cl. H04J 3/04

(52) U.S. Cl. 370/535; 370/386

(57) ABSTRACT

A communication network capable of dynamically setting hierarchical high order and low order paths between arbitrary nodes is implemented. In the communication network including a plurality of nodes and a plurality of link groups connecting these nodes, a low order node having a switch for switching the low order path and a high order node having the switch for at least switching the high order path are provided as the plurality of nodes. The high order node further has a multiplexer for multiplexing N (N is an integer of 2 or more) of the low order paths on one of the high order paths and a separator for separating one of the high order paths into N of the low order paths. The low order path is set between any two nodes and the high order path is set between any two high order nodes.

### BACKGROUND OF THE INVENTION

1. Field of the Invention

The present invention relates to a communication network, a path setting method and a node apparatus used therefore, and in particular to the communication network having a hierarchical path and the path setting method for setting the hierarchical path in such a communication network, and is applicable to a method of setting a wavelength path and a wavelength group path in a wavelength multiplexing optical communication network for instance.

2. Description of the Prior Art

In the present public communication network, a standard called SONET (Synchronous Optical Network) or SDH (Synchronous Digital Hierarchy) is mainly used. In the SONET/SDH, a path is defined as a time division multiplex channel used for communication between terminal points.

While development of a wavelength multiplexing optical communication network using a wavelength multiplexing technology is promoted lately, there is also a concept called a wavelength path in that communication network, wherein one wavelength of light is assigned as a communication channel between terminal points, where, as the node apparatus for switching the wavelength path, an optical branching and inserting apparatus is used in the case of a ring network and an optical crossconnect apparatus is used in the case of a mesh network. There are the cases where one physical wavelength is actually assigned as the wavelength path, and there is also a path called a virtual wavelength path wherein a different wavelength is assigned to each hop of the path.

In the wavelength multiplexing optical communication network, it is also thinkable to perform switching not in the unit of a wavelength but in the unit of a wavelength group comprised of a plurality of wavelengths or an optical fiber on which the plurality of wavelengths are multiplexed. For instance, a configuration of the optical crossconnect apparatus for performing switching in the unit of the wavelength group is disclosed in K. Harada et al., “Hierarchical Optical Path Cross-connect Systems for Large Scale WDM Networks”, OFC/100C '99, WM55, 1999. In such a wavelength multiplexing optical communication network using the node apparatus for performing switching in the unit of the wavelength group, it is possible to set a wavelength group path between the nodes.

In the node apparatus using an optical switch, one port of the optical switch is taken up by one path either in the case of switching the wavelength path or in the case of switching the wavelength group path. Accordingly, node costs can be reduced by setting one wavelength group path between two nodes to decrease the number of the ports required by the node apparatus in between rather than setting a plurality of wavelength paths there. The wavelength multiplexing optical communication network for switching the wavelength group path in this way is disclosed in Nakajima et al. “Large-Capacity Optical Cross-Connect Architectures Considering Increase of Traffic”, Shingaku Gihou SSE2000-189, Denshi Joho Tsushin Gakkai, 2000.

While only the wavelength path and the wavelength group path were described above, the optical communication network for setting an optical fiber path by using the node apparatus for performing the switching in the unit of the optical fiber is also thinkable. If the path having a larger bandwidth is referred to as a high order path, the wavelength group path is a higher-order path than the wavelength path, and the optical fiber path is a higher-order path than the wavelength group path. Thus, there is a hierarchy as to granularity of the path in the wavelength multiplexing optical communication network.

This concept of the hierarchical path exists not only in the wavelength multiplexing optical communication network, but it is also possible, in time division multiplex communication network such as SONET, to consider the path of a low degree of time division multiplexing (narrow bandwidth or small bandwidth) as the low order path and that of a high degree of time division multiplexing (wide bandwidth or large bandwidth) as the high order path.

As for the wavelength multiplexing optical communication network, introduction of an advanced control plane is considered in order to set and release the path at high speed or automatically. Functions of the control plane include routing for determining the route of the path and signaling for communicating control information necessary to set and release the path for instance. Such a control plane is disclosed in an Internet draft of the Internet Engineering Task force (IETF), draft-many-ip-optical-framework-01. txt. It is also possible to render the aforementioned wavelength path, wavelength group path, optical fiber path and so on as control objects of such a control plane.

In the aforementioned example of the wavelength multiplexing optical communication network for switching the wavelength group path, the entire route between the two nodes that are terminal points of the path is the wavelength group path. To be more specific, the bandwidth of the wavelength group path cannot be fully used and resources are wastefully consumed unless there is a communication demand equivalent to the bandwidth of the wavelength group path between the two nodes.

For instance, in the case where the bandwidth per wavelength is 10 Gb/s and one wavelength group is comprised of eight wavelengths, the bandwidth of one wavelength group path is 80 Gb/s. If there is actually a demand of 20 Gb/s only between the terminal points setting this wavelength group path, the remaining bandwidth of 60 Gb/s is wastefully consumed. In this case, while the number of ports required by the node is reduced to a half, the bandwidth required by the link is increased to four times.

### SUMMARY OF THE INVENTION

In order to solve this problem, it is necessary to flexibly mix the wavelength path and the wavelength group path in one network. To be more specific, a first object of the present invention is to implement the communication network flexibly mixing the high order and low order paths. If this object is attained, it is possible, even in the case where there is only a low demand compared to the bandwidth of the high order path between the two nodes, to collect a plurality of low order paths having different starting point and endpoint nodes so as to set the high order path and effectively use the bandwidth of the high order path that is set.

A concrete method of performing integrated routing of the high order and low order paths in the communication network mixing the high order and low order paths is not disclosed as of this point in time. It is possible, in the past network using the SONET and so on, to design the routes of the high order and low order paths in advance respectively so as to consequently configure the hierarchical paths. In such a communication network, however, the high order path is strictly static. Even if the low order path is dynamically set according to the demand in the SONET network, there was no method of dynamically setting the high order path in conjunction therewith. To be more specific, a second object of the present invention is to provide the method of dynamically setting the high order path between arbitrary nodes in the communication network where the hierarchical paths exist.

According to the present invention, it is possible to acquire a communication network including a plurality of nodes and a plurality of link groups connecting these nodes, wherein the above described nodes include: a first node having a switch for switching a path having a predetermined bandwidth (hereafter, referred to as a low order path); and a second node having a switch for switching the above described low order path, a switch for switching a path having a bandwidth larger than the above described predetermined bandwidth (hereafter, referred to as a high order path), multiplexing means of multiplexing N (N is an integer of 2 or more) of the above described low order paths on one of the above described high order paths, and separating means of separating one of the above described high order paths into N of the above described low order paths, and the above described low order path is set between any two of the above described nodes and the above described high order path is set between any two of the above described second nodes.

And all the above described nodes may be the above described high order nodes. And as its characteristic, a centralized control unit capable of communication with all the above described nodes and having a path table recording route information on all the above described existing low order paths is provided, and the above described low order and high order paths are set predominantly (actively) by the above described centralized control unit.

Moreover, as its characteristic, every above described node has a node control unit having the path table recording route information on all the low order paths passing that node, and the above described low order and high order paths are set predominantly by the above described node control unit. Furthermore, as its characteristic, the above described low order path is the wavelength path and the above described high order path is the wavelength group path. In addition, as its characteristic, the above described low order path is the wavelength path and the above described high order path is the optical fiber path. Furthermore, as its characteristic, the above described low order path is the wavelength group path and the above described high order path is the optical fiber path.

According to the present invention, it is possible to acquire the path setting method in a communication network including the first node having the switch for switching the low order path and the second node having the switch for switching the above described low order path, the switch for switching the high order path, the multiplexing means of multiplexing N (N is an integer of 2 or more) of the above described low order paths on one of the above described high order paths, and the separating means of separating one of the above described high order paths into N of the above described low order paths, and a plurality of link groups connecting these nodes, wherein: in the case where N (N is an integer of 2 or more) of the above described low order paths having the route partly coinciding with a section connecting any two of the above described high order paths exist, the high order path on which the N of the above described low order paths are multiplexed is set in the above described section.

According to the present invention, it is possible to acquire a path setting method in a communication network including the first node having the switch for switching the above described low order path and the second node having a switch for switching the above described low order path, a switch for switching the above described high order path, the multiplexing means of multiplexing N (N is an integer of 2 or more) of the above described low order paths on one of the above described high order paths, and the separating means of separating one of the above described high order paths into N of the above described low order paths, and the plurality of link groups connecting these nodes, wherein on the route of a first low order path having any two of the above described first node or the above described second node as its starting point node and endpoint node, attention is paid to the section that is a part of the above described route in predetermined order, and if the second to N-th (N is an integer of 2 or more) low order paths of which route partly coincides with the above described section exist, the high order path on which the first to N-th low order paths are multiplexed is set in the above described section.

And as its characteristic, if length of the route of the above described first low order path is L, the attention is paid first to the section that is entirety of the above described route, and then to all the sections of which length is L-1, and thereafter to all the sections of which length is L-2, L-3, . . . , 2 in order, and also as its characteristic, if length of the route of the above described first low order path is L, the attention is paid first to the sections having as one terminal point the starting point node of the above described first low order path of which length is L, L-1, L-2, . . . , 2, and then to the sections having as one terminal point the node on the endpoint node side by 1 hops from the above described starting point node of which length is L-1, L-2, L-3, . . . , 2, and thereafter to the sections having as one terminal point the node on the endpoint node side by 1 hops from the above described starting point node of which length is L-I, L-I-1, L-I-2, . . . , 2 in order of I=2, 3, 4 . . . , L-2.

According to the present invention, it is possible to acquire a node apparatus in the communication network including: the switch for switching the low order path; the switch for switching the high order path; the multiplexing means of multiplexing N (N is an integer of 2 or more) of the above described low order paths on one of the above described high order paths; the separating means of separating one of the above described high order paths into N of the above described low order paths; and node controlling means having the path table recording the route information on all the low order paths passing that node, and wherein the above described low order and high order paths are set by the above described node controlling means.

### BRIEF DESCRIPTION OF THE DRAWINGS

FIG. 1 is a block diagram of a communication network according to a first embodiment;

FIG. 2 is a block diagram of a node in the first embodiment;

FIG. 3 is a block diagram of a crossconnect apparatus in the first embodiment;

FIG. 4 is a diagram showing a state before setting a wavelength group path in the first embodiment;

FIG. 5 is a diagram showing a state after setting the wavelength group path in the first embodiment;

FIG. 6 is a flowchart showing a path setting algorithm in the first embodiment;

FIG. 7 is a flowchart showing the path setting algorithm in the first embodiment;

FIG. 8 is a block diagram of the communication network according to a second embodiment;

FIG. 9 is a block diagram of the node in the second embodiment;

FIG. 10 is a flowchart showing the path setting algorithm in the second embodiment;

FIG. 11 is a flowchart showing the path setting algorithm in the second embodiment; and

FIGS. 12A and 12B show concrete examples of a routing table in a node X in the embodiment, where FIG. 12A is before modification and FIG. 12B is after the modification.

### DETAILED DESCRIPTION OF THE PREFERRED EMBODIMENTS

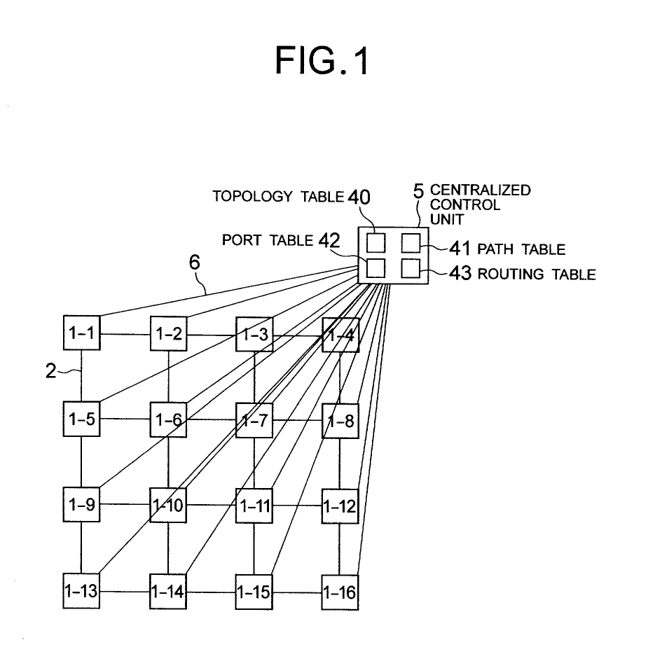

FIG. 1 shows configuration of a wavelength multiplexing optical communication network according to a first embodiment of the present invention. In this network, sixteen nodes 1-1 to 1-16 are connected by a bidirectional link group 2 in a state of square gratings. The link group 2 is comprised of eight bidirectional links. To be more specific, it is comprised of two optical fibers of which directions for transmitting signals are mutually opposite, and each optical fiber has a light signal of eight wavelengths multiplexed.

In this embodiment, the wavelength path and the wavelength group path are bidirectional, and one terminal point of the path is called a starting point node and the other is called an endpoint node, where the starting point node side seen from a node in between is called an upward direction and the endpoint node side is called a downward direction. In addition, each node is capable of communication with a centralized control unit 5 via a control signal line 6. Moreover, the centralized control unit 5 has a topology table 40, a path table 41, a port table 42 and a routing table 43, which will be described later.

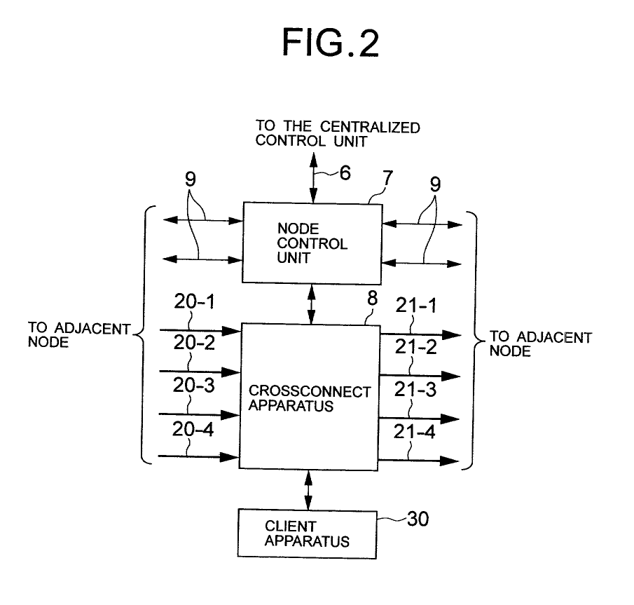

FIG. 2 shows the configuration of a node 1. The node 1 is comprised of a node control unit 7, a crossconnect apparatus 8 and a client apparatus 30. The node control unit 7 is connected to the centralized control unit 5 by the control signal line 6, and is connected to the node control unit 7 of the adjacent node by control signal lines 9. The control signal lines 6 and 9 are used for communication of control information required for path setting and so on.

The crossconnect apparatus 8 is connected to input optical fibers 20 and output optical fibers 21. The input optical fibers 20 and output optical fibers 21 are the optical fibers constituting the link group 2, and are connected to the adjacent nodes. For instance, in the case of a node 1-6, an input optical fiber 20-1 and an output optical fiber 21-1 are connected to a node 1-2, an input optical fiber 20-2 and an output optical fiber 21-2 are connected to a node 1-5, an input optical fiber 20-3 and an output optical fiber 21-3 are connected to a node 1-7, and an input optical fiber 20-4 and an output optical fiber 21-4 are connected to a node 1-10, respectively.

As a node in a peripheral portion of the network is only connected to the lines in two or three directions, two or one input optical fibers 20 and output optical fibers 21 will be left in that case. A client apparatus 30 is typically an IP (Internet Protocol) router, and performs communication with the client apparatus 30 of another node via the wavelength path and the wavelength group path.

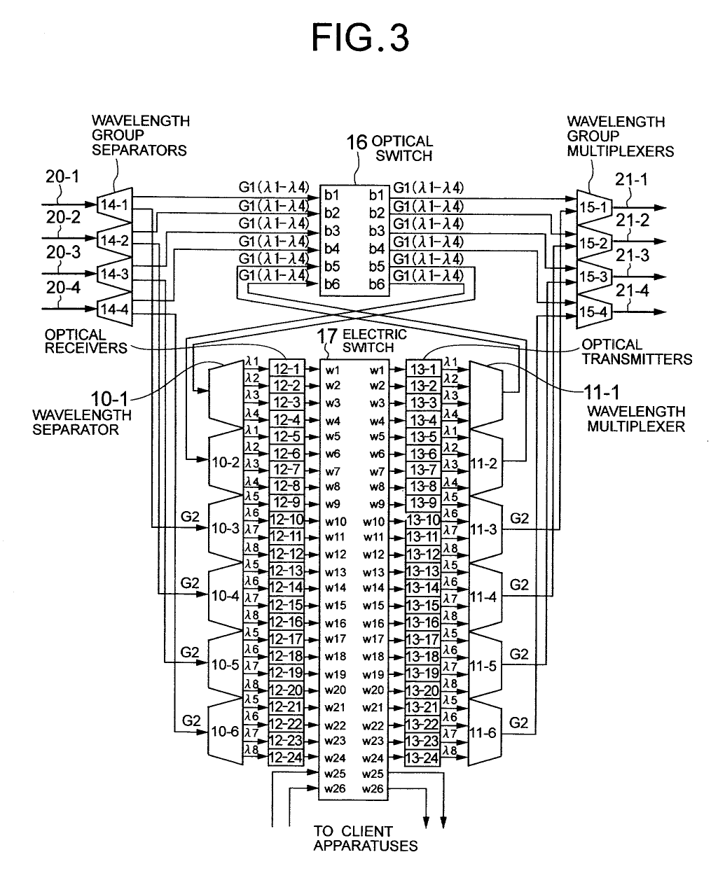

FIG. 3 shows the configuration of the crossconnect apparatus 8. The crossconnect apparatus 8 switches the wavelength path and the wavelength group path between the input optical fibers 20-1, 20-2, 20-3 and 20-4 and the output optical fibers 21-1, 21-2, 21-3 and 21-4. The wavelength multiplexing light signals of wavelengths λ1 to λ8 inputted from the input optical fibers 20-1 to 20-4 are separated into two wavelength multiplexing light signals, that is, a wavelength group G1 consisting of the wavelengths λ1 to λ4 and a wavelength group G2 consisting of the wavelengths λ5 to λ8 by wavelength group separators 14-1 to 14-4 respectively.

The wavelength multiplexing light signals of the wavelength group G1 are inputted as-is to an optical switch 16, and the wavelength multiplexing light signals of the wavelength group G2 are inputted to wavelength separators 10-3 to 10-6. The wavelength multiplexing light signals of the wavelength group G2 inputted to the wavelength separators 10-3 to 10-6 are further separated into the light signals of the wavelengths λ5, λ6, λ7 and λ8 and converted into electric signals by optical receivers 12 to be inputted to an electric switch 17 thereafter. The wavelength multiplexing light signals of the wavelength group G1 outputted from two ports of the optical switch 16 are separated by the wavelength separators 10-1 and 10-2 into the light signals of the wavelengths λ1, λ2, λ3 and λ4 and converted into the electric signals by the optical receivers 12 to be inputted to the electric switch 17 thereafter. And two input ports and two output ports of the electric switch 17 are connected to the client apparatus 30, respectively.

On the other hand, the electric signals outputted from the eight output ports of the electric switch 17 are converted into the light signals of the wavelengths λ1, λ2, λ3 and λ4 by optical transmitters 13-1 to 13-8 and multiplexed on the wavelength multiplexing light signals of the wavelength group G1 by a wavelength multiplexer 11-1 to be inputted to the optical switch 16. The optical switch 16 performs switching in the unit of the wavelength group between six input ports and six output ports, whereas the electric switch 17 performs switching in the unit of the wavelength between twenty-six input ports and twenty-six output ports.

The wavelength multiplexing light signals of the wavelength group G1 outputted from the optical switch 16 are inputted as-is to wavelength group multiplexers 15, and the electric signals outputted from the electric switch 17 are converted by optical transmitters 13 into the light signals of the wavelengths λ5, λ6, λ7 and λ8 and multiplexed on the wavelength multiplexing light signals of the wavelength group G2 by the wavelength multiplexers 11 to be inputted to the wavelength group multiplexers 15. The wavelength group multiplexers 15 multiplex the wavelength multiplexing light signals of the wavelength groups G1 and G2 and outputs them to the output optical fibers 21-1 to 21-4.

The ports of the optical switch 16 and the electric switch 17 are given port numbers of b1 to b6 and w1 to w26 as shown in the drawing respectively. As a bidirectional path is assumed, a pair of the input and output ports is assigned to one path, and this pair is represented by one port number.

A method of setting the wavelength path and the wavelength group path in this network will be described hereafter. This embodiment is a centralized control type network, where the centralized control unit 5 determines the route of the wavelength path. For that reason, the centralized control unit 5 has the topology table 40 for showing a connection between the nodes and a state of using the wavelength and the path table 41 for recording path numbers, routes and so on of the wavelength paths and the wavelength group path.

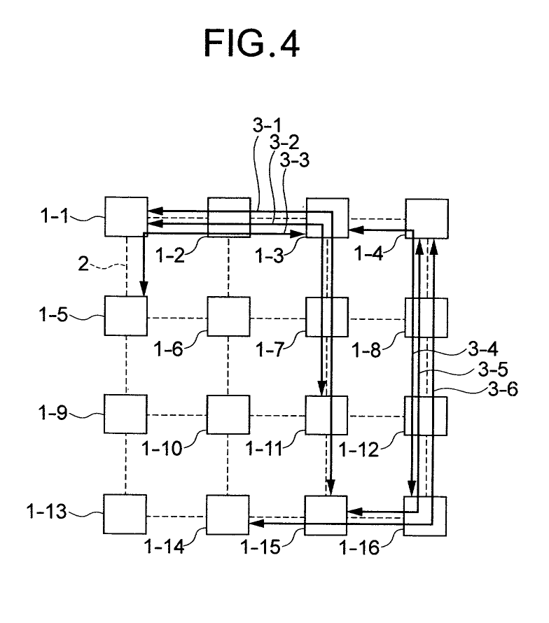

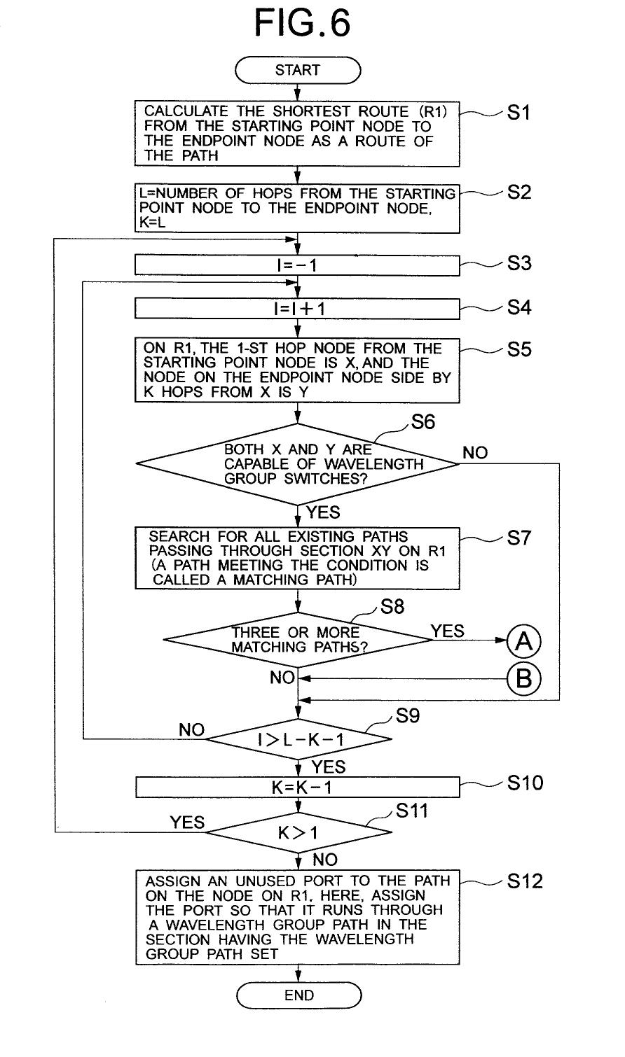

Control for setting the wavelength path and the wavelength group path is performed based on an algorithm shown in the flowchart in FIG. 6. Now, it is assumed that wavelength paths 3-1, 3-2, 3-3, 3-4, 3-5 and 3-6 are set in this network as shown in FIG. 4. Here, the case of setting a wavelength paths 3-7 of which starting point is the node 1-1 and endpoint is a node 1-16 is considered.

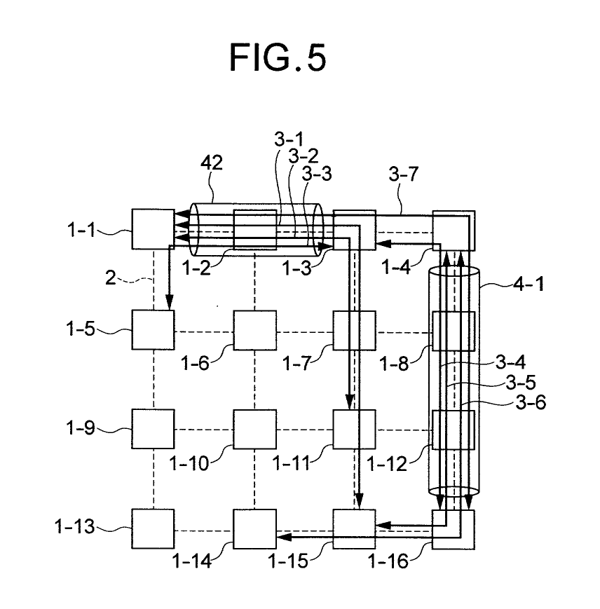

The centralized control unit 5 first refers to the topology table 40 and calculates the shortest route from the starting point node 1-1 to the endpoint node 1-16 using only the link group 2 having an unused wavelength (step S1). As for the method of such route calculation, a CSPF algorithm described in pp. 175 to 180 of B. Davie et al., “MPLS Technology and Applications,” Morgan Kaufmann Publishers, 2000 and so on can be used. Here, it is assumed that the route shown as the wavelength paths 3-7 in FIG. 5 is obtained, and this route is called R1 hereafter.

The centralized control unit 5 sets 0 as the value of a variable I, and sets the hop number L, that is, 6 of the route R1 as the value of a variable K (step S2). Here, a first node on the route R1, that is, the node 1-1 is a node X, and the node on the endpoint node side on the route R1 by K hops from the node X, that is, the node 1-16 is a node Y (steps S3 to S5).

When both the nodes X and Y have wavelength group switches, the centralized control unit 5 searches the path table 41 to look for an existing wavelength path 3 running through a section XY between the nodes X and Y (steps S6 and S7). In this embodiment, while this search is performed without fail since every node 1 has the optical switch 16 as the wavelength group switch, it is not performed in case either node X or Y does not have the wavelength group switch. Here, the section XY is the route R1 itself, and there is no existing wavelength path running through this section (step S8).

Next, the centralized control unit 5 compares I to L-K-1 (step S9). Here, since it is I=0 and L-K-1=−1, it is I>L-K-1, and the centralized control unit 5 subtracts 1 from K to make it K=5 (step S10). As understood so far, K indicates the hop number of the section XY for performing the search for the existing wavelength path.

Subsequently, the centralized control unit 5 makes the search for the existing wavelength path running through the section XY as I=0 again (step S11, S3 and S4). Here, the section XY is the section from the node 1-1 to the node 1-12 on the route R1. Since there is also no existing wavelength path running through this section, it is I=L-K-1=0 if I is compared to L-K-1 this time. Thus, the centralized control unit 5 adds 1 to I to make it I=1 (step S4). Though the section XY is from the node 1-2 to the node 1-16 this time, there is also no existing wavelength path running through this section. Since it is I=1 and L-K-1=0, I>L-K-1 this time. Therefor, the centralized control unit 5 subtracts 1 from K to make it K=4.

The centralized control unit 5 continues the control likewise thereafter, and consequently the section XY becomes as follows (provided that the section XY is represented as (X, Y)), and the search is made in this order.

(1-1, 1-16), (1-1, 1-12), (1-2, 1-16),

(1-1, 1-8), (1-2, 1-12), (1-3, 1-16),

(1-1, 1-4), (1-2, 1-8), (1-3, 1-12),

(1-4, 1-16), (1-1, 1-3), (1-2, 1-4),

(1-3, 1-8), (1-4, 1-12), (1-8, 1-16)

To be more specific, the section XY to be searched is shifted hop by hop from the starting point node toward the endpoint node, and if it reaches the endpoint, the length K of the section XY is shortened by one hop, and then the search is made again while shifting hop by hop from the starting point node toward the endpoint node. The search is finished when the length K of the section XY becomes 1 (step S11).

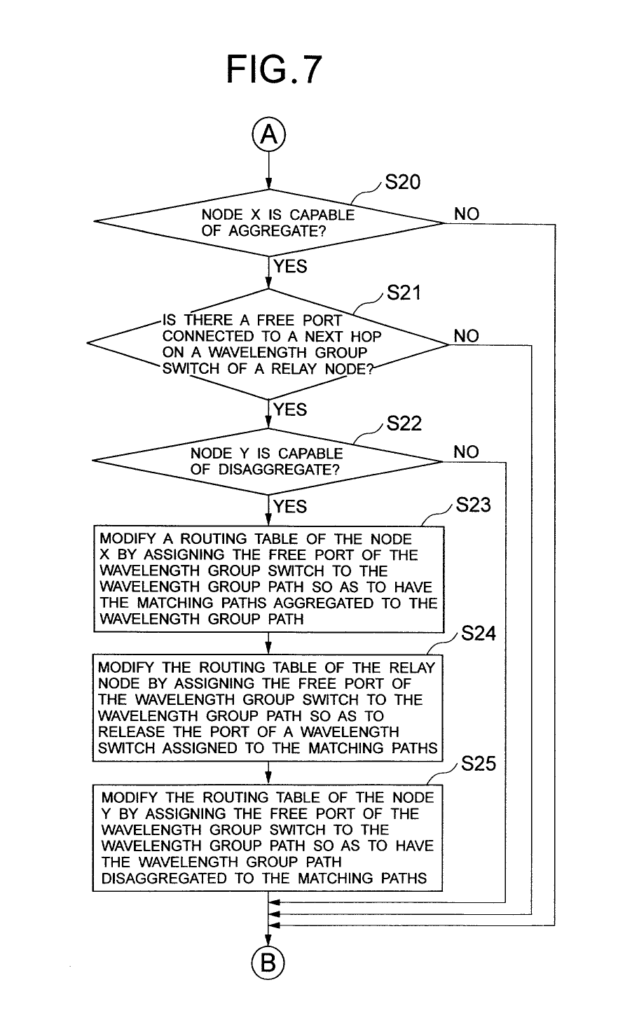

If the search for the existing wavelength path is performed as set forth above, the wavelength paths 3-4, 3-5 and 3-6 are found first as the existing wavelength paths running through the section (1-4, 1-16) (hereafter, a found path will be referred to as a matching path) (step S7). When the number of the matching paths is (the number of the wavelengths forming the wavelength group)−1 or larger, that is, 3 or more in this embodiment (step S8), the centralized control unit 5 sets the wavelength group path 4-1 here, and tries to multiplex on the set wavelength group path 4-1 the wavelength path 3-7 just to be set and the wavelength paths 3-4, 3-5 and 3-6 that are the matching paths. (Hereafter, multiplexing a plurality of wavelength paths on the wavelength group path is referred to as aggregate, and separating the wavelength group path into the plurality of wavelength group paths is referred to as disaggregate). The wavelength group path is set based on the algorithm shown in the flowchart in FIG. 7.

The centralized control unit 5 has the port table 42 for showing the state of using the ports of each node 1, the connections with adjacent nodes, correspondence between the ports and the wavelengths and so on and also a routing table 43 for showing which ports the wavelength paths and the wavelength group paths are assigned to in each node. First, the centralized control unit 5 checks whether or not the node X is capable of aggregate (step S20).

To be more specific, it checks the following two points.

(1) Among the ports b1 to b4 of the optical switch 16, whether or not there is one or more free ports among those connected to a downstream node.

(2) Among the ports b5 to b6 of the optical switch 16, whether or not there is one or more free ports (step S20).

The state of using the ports can be obtained by referring to the port table 42. If both these conditions are met, next, the centralized control unit 5 checks, among the ports b1 to b4 of the optical switch 16 of each node 1 (relay node) between X and Y, whether or not there is one or more free ports among those connected to the downstream node (step S21). If there is an unused port for every relay node, it subsequently checks whether or not the node Y can disaggregate the wavelength group path. Here, it checks, among the ports b5 to b6 of the optical switch 16, whether or not there is one or more free ports (step S22).

While setting of the wavelength group path 4 is stopped in the case where, among the conditions of the above steps S20 to S22, there is even one that is not met, all the conditions are met here. Thus, the centralized control unit 5 modifies the routing tables of all the nodes 1 in the section XY so as to set the wavelength group path 4-1 of which starting point is the node X and endpoint is the node Y.

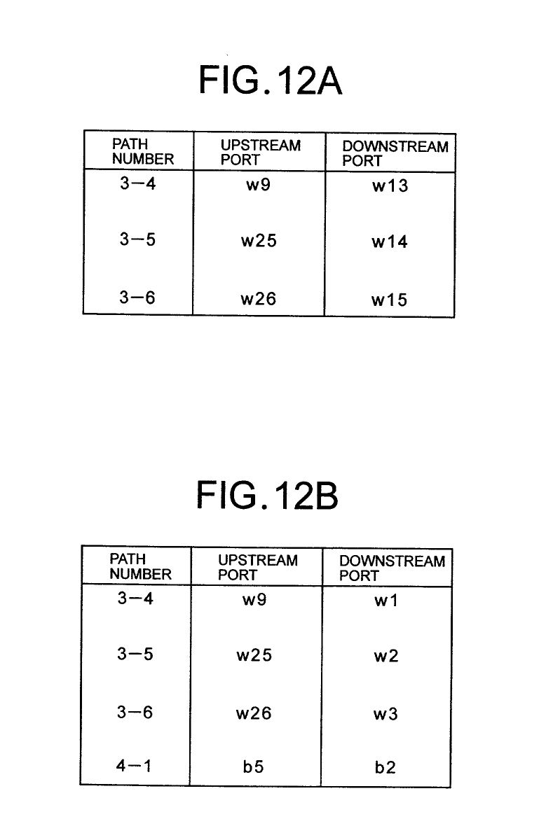

First, the routing table of the node 1-4 that is the node X is as in FIG. 12A before modification, which is modified as in FIG. 12B. To be more specific, it first assigns to the wavelength group path 4-1 the port b5 that is the unused port connected to the electric switch 17 of the optical switch 16 as an upstream port and the port b2 that is the unused port connected to the downstream node (node 1-8) of the optical switch 16 as a downstream port. As for the wavelength paths 3-4, 3-5 and 3-6, while w13, w14 and w15 are originally assigned to them as the downstream port, it modifies them so as to assign w1, w2 and w3 connected to the upstream port b5 of the wavelength group path 4-1 thereto (step S23).

Next, it modifies the routing tables of relay nodes 1-8 and 1-12. It assigns to the wavelength group path 4-1 the port of the optical switch 16 connected to the downstream port assigned to the upstream node as the upstream port (it is possible to know, by referring to the port table 42, which port of a certain node is connected to which port of the adjacent node) and the unused port of the optical switch 16 connected to the downstream node as the downstream port. It releases to the wavelength paths 3-4, 3-5 and 3-6 all the ports assigned as the upstream and downstream ports (step S24).

Lastly, it modifies the routing table 43 of the node 1-16 that is the node Y. It assigns to the wavelength group path 4-1 the port of the optical switch 16 connected to the downstream port assigned to the upstream node (node 1-12) as the upstream port and the unused port of the optical switch 16 connected to the electric switch 17 as the downstream port. As the upstream port, it changes the port connected to the upstream node (nodes 1-12) of the electric switch 17 originally assigned to the wavelength paths 3-4, 3-5 and 3-6 so as to assign the port connected to the port of the optical switch 16 assigned as the downstream port of the wavelength group path 4-1 (step S25).

The wavelength group path 4-1 is set as forth above, and the wavelength paths 3-4, 3-5 and 3-6 run therein, and so the centralized control unit 5 returns to the flowchart in FIG. 6 and continues the search for the matching path (step S9).

If it continues the search, the wavelength paths 3-1, 3-2 and 3-3 are found as the matching paths in the section (1-1, 1-3). Here, the wavelength group path 4-2 is also set just as in the case of the wavelength group path 4-1, and the wavelength paths 3-1, 3-2 and 3-3 run therein.

If the setting of the wavelength group path 4 in conjunction with the setting of the wavelength paths 3-7 is finished as above, the setting of the routing table 43 of each node 1 on the route R1 is performed for the sake of the wavelength paths 3-7 (step 12). First, it assigns the unused port connected to the client apparatus 30 as the upstream port of the starting point node (node 1-1) and the unused port of the electric switch 17 connected to the upstream port assigned to the wavelength group path 4-2 as the downstream port thereof. As for the node 1-2, no port is assigned since the wavelength paths 3-7 is running in the wavelength group path 4-2.

As for the node 1-3, it assigns the port connected to the downstream port assigned to the wavelength path 3-7 (it is possible to know, by referring to the port tables 42 of the nodes 1-1 and 1-3, which port of the node 1-1 is connected to which port of the node 1-3 from the correspondence of the ports and the wavelengths) on the upstream node (node 1-1) as the upstream port and the unused port of the electric switch 17 connected to the downstream node (node 1-4) as the downstream port.

Hereafter, it likewise assigns the unused port of the electric switch 17 connected to the downstream node in any section where the wavelength group path is not set and the port for running in the wavelength group path in any section where the wavelength group path is set respectively so as to set the routing table 43 of every node to the wavelength path 3-7.

Lastly, a switching command of the optical switch 16 and the electric switch 17 is sent from the centralized control unit 5 to each node 1 on the route R1 in compliance with the routing table 43 so that the setting of the wavelength path 3-7 is finished.

If the attention is paid to the totals of the numbers of the required ports of the optical switch 16 and the electric switch 17 of each node in the case where the wavelength group paths 4-1 and 4-2 are set and in the case where they are not set, the number of the required ports increases by two ports on the nodes 1-1, 1-3, 1-4 and 1-16 that are the terminal points of the wavelength group path, whereas it decreases by six ports on the nodes 1-2, 1-8 and 1-12 that are the relay nodes thereof, because the wavelength group paths 4 were set. Accordingly, ten ports in total are reduced after all by setting the wavelength group paths 4.

As is also understandable from FIG. 5, it is possible in this embodiment to aggregate a plurality of wavelength paths 3 having mutually different starting point nodes or endpoint nodes in the wavelength group path 4. Thus, even though there is only a demand of one wavelength between the starting point node and the endpoint node of each wavelength path 3, it is possible to aggregate those wavelength paths 3 and set the wavelength group path 4.

In addition, as every node 1 has the optical switch 16 for switching the wavelength group path in this embodiment, it is possible to aggregate to the wavelength group path or disaggregate therefrom as required on an arbitrary node. As a result, the route of the wavelength path always becomes the shortest and no wavelength in the wavelength group path remains unused.

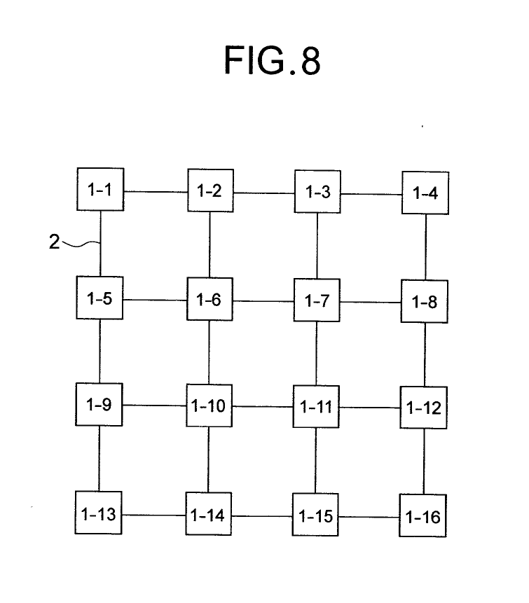

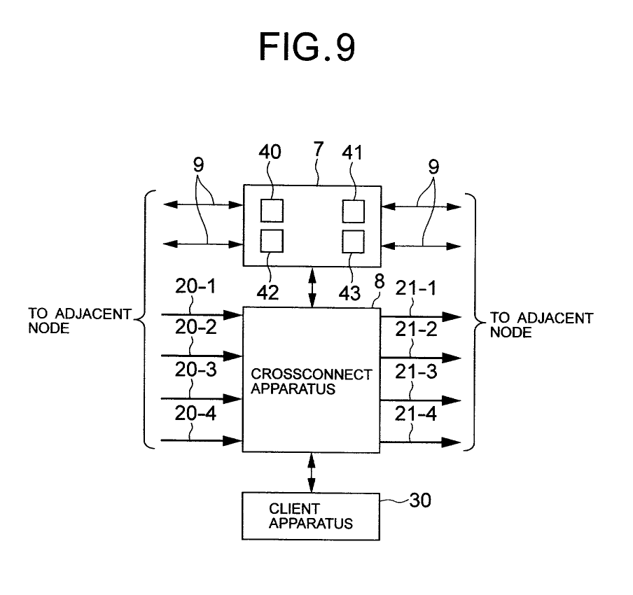

FIG. 8 shows the configuration of the wavelength multiplexing optical communication network in the second embodiment of the present invention. The configuration of this network is equal to that of the first embodiment except that there are no centralized control unit 5 and control signal line 6. FIG. 9 shows the configuration of the node 1 of this embodiment. The node 1 has the topology table 40, the path table 41, the port table 42 and the routing table 43 inside the node control unit 7, and has no control signal line 6. Otherwise, it is equal to the configuration of the node 1 of the first embodiment.

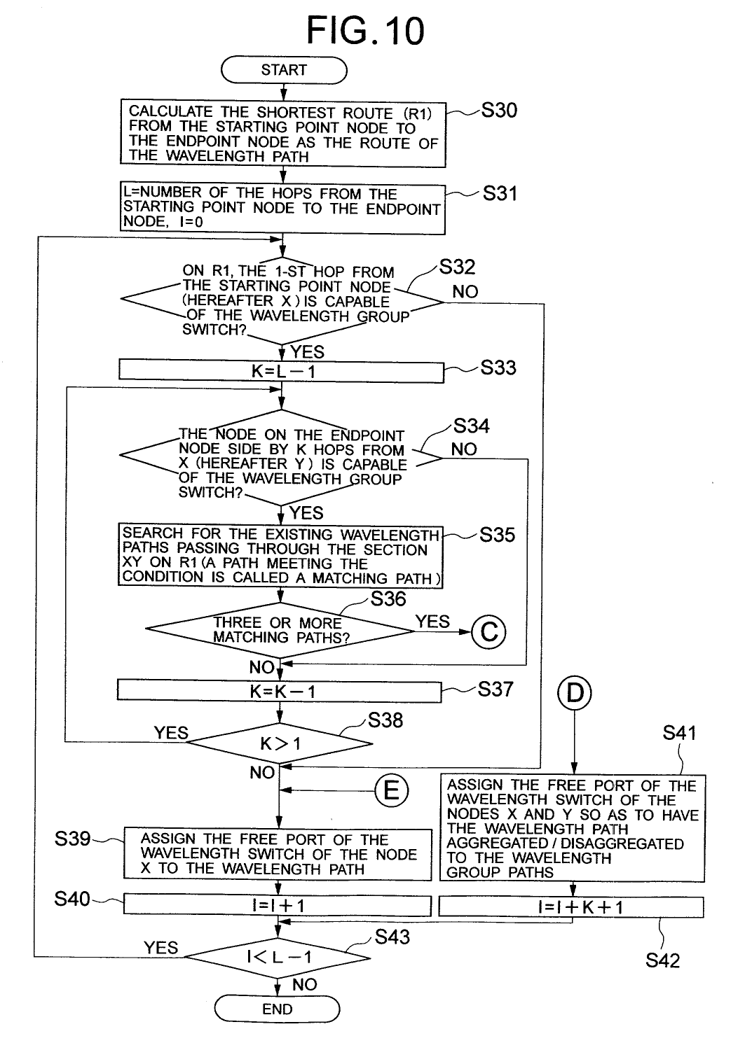

This embodiment is a decentralized control type network, where the node 1 as the starting point of the wavelength path 3 determines the route of the wavelength path 3. The control for setting the wavelength path 3 and the wavelength group path 4 is exerted based on the algorithm shown in the flowchart in FIG. 10.

Here, as in the case of the first embodiment, the case where the wavelength path 3-7 of which starting point is the node 1-1 and endpoint is the node 1-16 is newly set, as shown in FIG. 4, in the state where the wavelength paths 3-1, 3-2, 3-3, 3-4, 3-5 and 3-6 are already set.

The node control unit 7 of the node 1-1 refers to the topology table 40 and uses only the link group 2 having the unused wavelength so as to calculate the shortest route from the starting point node 1-1 to the endpoint node 1-16 (step S30). Here, it is also assumed that the same route as the first embodiment is obtained, which is called the route R1.

Subsequently, the node 1-1 sets the variable I at 0 (step S31), and assumes that the node of the I-th hop from the starting point node, that is, the node itself is the node X. While the next process changes depending on whether or not the node 1-1 is capable of switching the wavelength group, every node 1 has the optical switch 16 in this embodiment so as to be capable thereof (step S32 and S34).

Then, the node 1-1 sets the variable K at L-I (step S33). Here, it is K=L=6 since L is the number of hops from the starting point node to the endpoint node and I is 0. In addition, the node 1-1 assumes the node 1 that is downstream by K hops from the node X to be the node Y. Here, the node 1-16 as the endpoint node is the node Y. The path table 41 of the node 1-1 has the path numbers and routes of all the wavelength paths 3 and the wavelength group paths 4 passing through that node recorded.

Thus, the node 1-1 searches this path table to look for the existing wavelength path 3 passing through the section XY (step S35). Here, as there is no existing wavelength path 3 meeting the condition (step S36), the node 1-1 subtracts 1 from K to make it K=5 (step S37). Though the node 1-1 searches again for the existing wavelength path 3 passing through the section XY based on the node Y by the new value of K, no wavelength path 3 meeting the condition exists here either.

Thereafter, the search for the wavelength path 3 passing through the section XY is performed while reducing K1 by 1, and then the wavelength paths 3-1, 3-2 and 3-3 running through the section (1-1, 1-3) are found when K=2 (hereafter, the found path will be referred to as the matching path). When the number of the matching paths (the number of the wavelengths forming the wavelength group) is −1 or larger, that is, 3 or more in this embodiment (step S36), the node 1-1 sets the wavelength group path 4-2 of which starting point node is the node X and endpoint node is the node Y, and tries to multiplex on the set wavelength group path the wavelength paths 3-1, 3-2 and 3-3 that are the matching paths with the wavelength path 3-7 just to be set.

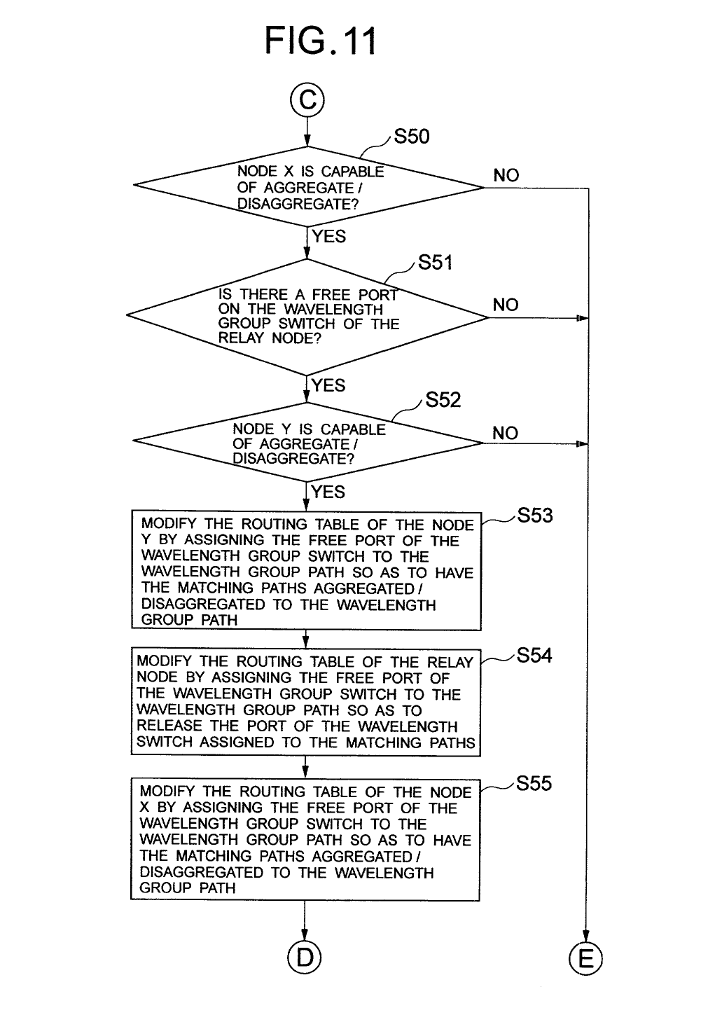

The wavelength group path 4-2 is set based on the algorithm shown in FIG. 11. First, the node 1-1 refers to the port table 42 to check whether or not it is possible to aggregate on the node itself (step S50). To be more specific, it checks the following two points.

(3) Among the ports b1 to b4 of the optical switch 16, whether or not there is one or more free ports among those connected to the downstream node.

(4) Among the ports b5 to b6 of the optical switch 16, whether or not there is one or more free ports.

If the conditions of both (3) and (4) are met, next, the node 1-1 generates a signaling packet to the node Y (node 1-3) and sends it to the downstream node (node 1-2). This signaling packet includes information such as the path number (4-2) of the path just to be set, a path type (wavelength group path), the starting point node (node 1-1) and the endpoint node (node 1-3).

The node 1-2 having received the signaling packet checks, among the ports b1 to b4 of the wavelength group switch 16, whether or not there is one or more free ports among those connected to the downstream node (step S51). If there is any free port, the node 1-2 transfers the signaling packet to the downstream node (node 1-3).

The node 1-3 having received the signaling packet checks whether or not it is possible to disaggregate the wavelength group path on the node itself (step S52). To be more specific, it checks, among the ports b5 to b6 of the optical switch 16, whether or not there is one or more free ports.

Among the conditions of the above steps S50 to S52, if there is even one that is not met, the signaling packet indicating that the setting of the wavelength group path 4-2 is impossible is sent back to the node X (node 1-1) and the setting thereof is stopped. In that case, the node X (node 1-1) resumes the setting of the wavelength path 3-7 and assigns the port of the electric switch 17. First, it assigns the unused port connected to the client apparatus 30 as the upstream port and the unused port connected to the downstream node (node 1-2) as the downstream port (step S39). Subsequently, the node 1-1 sends the signaling packet to the downstream node (node 1-2) and continues the setting of the wavelength path 3-7 (step S40 and S43).

As all the conditions of the above steps S50 to S52 are met here, the node 1-3 modifies its own routing table 43 to assign the port to the wavelength group path 4-2. It assigns the port connected to the electric switch 17 of the optical switch 16, that is, the unused port of the ports b5 and b6 as the downstream port and the unused port of the optical switch 16 connected to the upstream node (node 1-2) as the upstream port. As for the wavelength paths 3-1, 3-2 and 3-3, while the ports connected to the upstream node of the electric switch 17 are originally assigned to them as the upstream port, it modifies them so as to assign the ports connected to the port of the optical switch 16 assigned as the downstream port of the wavelength group path 4-2. At this time, the wavelength paths of smaller path numbers should have the ports of smaller port numbers assigned (step S53).

Subsequently, the node 1-3 generates the signaling packet addressed to the node 1-1 and sends it to the upstream node (node 1-2). This signaling packet includes the information such as the path number (4-2) of the path just to be set, a path type (wavelength group path), the starting point node (node 1-1), the endpoint node (node 1-3), that the setting of this path is possible and the port number as the upstream port assigned by the downstream node (node 1-3).

The node 1-2 having received the signaling packet also modifies its own routing table 43 to assign the port to the wavelength group path 4-2. First, it obtains from the received signaling packet the port number as the upstream port assigned by the downstream node (node 1-3), and then refers to its own port table 42 to obtain the number of the port of the node itself to which that port is connected. It assigns this as the downstream port. As for the upstream port, it assigns the unused port of the optical switch 16 connected to the upstream node (node 1-1). In addition, it releases all the ports assigned to the wavelength paths 3-1, 3-2 and 3-3 (step S54).

Subsequently, the node 1-2 rewrites the port number in the signaling packet with the number of the upstream port that it assigned and transfers it to the upstream node (node 1-1).

The node 1-1 having received the signaling packet assigns to the wavelength group path 4-2 the port connected to the upstream port assigned by the downstream node (node 1-2) as the downstream port and the unused port connected to the electric switch 17 of the optical switch 16 as the upstream port. Moreover, as for the wavelength paths 3-1, 3-2 and 3-3, the ports of the electric switch 17 connected to the downstream node (node 1-2) are originally assigned to them as the downstream port, but it modifies them so as to assign the ports connected to the upstream port assigned to the wavelength group path 4-2. At this time, the wavelength paths of smaller path numbers should have the ports of smaller port numbers assigned (step S55).

As the wavelength group path 4-2 is set as set forth above and the wavelength paths 3-1, 3-2 and 3-3 will run therein, it returns to the flowchart in FIG. 10 to continue the setting of the wavelength path 3-7 (step S41). The node 1-1 assigns the port of the electric switch 17 to the wavelength path 3-7. First, it assigns the unused port connected to the client apparatus 30 as the upstream port and the unused port connected to the upstream port assigned to the wavelength group path 4-2 as the downstream port.

The routing table 43 of the node 1-1 before and after the procedure so far is as shown in FIGS. 12A and 12B in this embodiment as in the first embodiment. Subsequently, the node 1-1 generates the signaling packet to the endpoint node (node 1-16) of the wavelength path 3-7 and sends it to the downstream node (node 1-2). This signaling packet includes the information such as the path number (3-7) of the path to beset, a path type (wavelength path), the starting point node (node 1-1), the endpoint node (node 1-16), the port number of the downstream port assigned to this path by the node itself and the lastly set number of the endpoint node (node 1-3) of the wavelength group path 4.

The node 1-2 having received the signaling packet first refers to the number of the endpoint node of the wavelength group path 4 lastly set in the signaling packet. As the node number (node 1-3) written here is more downstream than the node 1-2, the node 1-2 simply transfers this signaling packet to the downstream node (node 1-3).

The node 1-3 having received the signaling packet first refers to the number of the endpoint node of the wavelength group path 4 lastly set in the signaling packet. As the node number (node 1-3) written here is its own node number, the node 1-3 assigns the port of the electric switch 17 to the wavelength path 3-7. It assigns the unused port connected to the downstream port assigned to the wavelength group path 4-2 as the upstream port and the unused port connected to the downstream node (node 1-4) as the downstream port (step S41). Subsequently, the node 1-3 rewrites the downstream port number in the signaling packet with the number of the downstream port that it assigned to the wavelength path 3-7 and transfers it to the downstream node (node 1-4).

The node 1-4 having received the signaling packet first refers to the number of the endpoint node of the wavelength group path 4 lastly set in the signaling packet. As the node number (node 1-3) written here is more upstream than the node 1-4, the node 1-4 starts the search for the matching path (steps S42, S43, S32 and S33). The search for the matching path is performed by the same method as that performed by the node 1-1. The section XY searched for here will be in the following order.

(1-4, 1-16),

(1-4, 1-12), (1-8, 1-16)

In this case, the wavelength paths 3-4, 3-5 and 3-6 are found as the wavelength paths 3 for passing through the section (1-4, 1-16). Thus, the wavelength group path 4-1 is set according to the algorithm shown in FIG. 11 as in the case of the wavelength group path 4-2 again.

Once the wavelength group path 4-1 is set, and the routing tables 43 of the nodes 1-4, 1-8, 1-12 and 1-16 are modified to have the wavelength paths 3-4, 3-5 and 3-6 pass inside the wavelength group path 4-1, the node 1-4 assigns the port of the electric switch 17 to the wavelength path 3-7. It assigns the port connected to the upstream port assigned by the node 1-3 written on the signaling packet received from the node 1-3 as the upstream port and the unused port connected to the upstream port assigned to the wavelength group path 4-1 as the downstream port (step S41).

Subsequently, the node 1-4 rewrites the port number of the downstream port and the number of the node Y of the lastly set wavelength group path 4 in the signaling packet received from the node 1-3 and transfers it to the downstream node (node 1-8). The nodes 1-8 and 1-12 transfer this signaling packet as-is to the downstream node.

If the node 1-16 receives the signaling packet, it assigns the port of the electric switch 17 to the wavelength path 3-7. First, since the node 1-16 is the endpoint node of the wavelength group path 4-1, it assigns the unused port connected to the downstream port assigned to the wavelength group path 4-1 as the upstream port. And since the node 1-16 is the endpoint node of the wavelength path 3-7, it assigns the unused port connected to the client apparatus 30 as the downstream port (steps S41 and S42, and then NO in S43).

Subsequently, the node 1-16 switches the optical switch 16 and the electric switch 17 according to the contents of the routing table 43. Furthermore, it generates the signaling packet to the node 1-1 and sends it to the upstream node (node 1-12). This signaling packet includes the information such as the path number (3-7) of the path to be set, the path type (wavelength path), the starting point node (node 1-1), the endpoint node (node 1-16) and that the assignment of the port to this path is complete.

The node 1-12 having received the signaling packet switches the optical switch 16 and the electric switch 17 according to the contents of the routing table 43, and transfers the signaling packet to the upstream node (node 1-8).

Thereafter, the nodes 1-8, 1-4, 1-3 and 1-2 switch the optical switch 16 and the electric switch 17 likewise according to the contents of the routing tables 43, and transfer the signaling packets to the upstream node.

Lastly, the node 1-1 receives the signaling packet and switches the optical switch 16 and the electric switch 17 according to the contents of the routing table 43, so that the settings of the wavelength path 3-7, the wavelength group paths 4-1 and 4-2 are complete.

This embodiment also allows same effect as that obtained in the first embodiment to be obtained. In these first and second embodiments, it is possible to arbitrarily set the number of the nodes 1, the number of the ports of the nodes 1, the number of the link groups, the number of the links comprising the link groups, the configuration of the network and so on.

In the first and second embodiments of the present invention, every node 1 has the optical switch (wavelength group switch) 16 but every node 1 does not need to have the wavelength group switch. Even if every node 1 does not have the wavelength group switch, it is possible to set the wavelength group paths 4 by using the algorithms shown in the flowcharts in FIG. 6 and FIG. 7 or FIG. 10 and FIG. 11.

While the electric switch 17 is used as the wavelength switch and the optical switch 16 is used as the wavelength group switch in the above first and second embodiments, it is also possible to use the optical switch as the wavelength switch and the electric switch as the wavelength group switch.

In addition, while the wavelength path is used as a low order path and the wavelength group path is used as a high order path in the above first and second embodiments, the low order and high order paths are not limited thereto. For instance, the wavelength group path may be used as the low order path and the optical fiber path for switching in the unit of the optical fiber may be used as the high order path, or the wavelength path nay be used as the low order path and the optical fiber path as the high order path.

Moreover, while the above first and second embodiments are the wavelength multiplexing optical communication networks, the invention hereof is also applicable to other communication networks. For instance, it is also possible, even in a network using time division multiplex technology such as SONET, to aggregate the low order path to the high order path just as in the first and second embodiments, regarding the path of a low degree of time division multiplexing as the low order path and that of a high degree thereof as the high order path.

Furthermore, although the first embodiment is a centralized control type and the second embodiment is a decentralized control type, it is possible to implement the algorithms in FIG. 6 and FIG. 7 used in the first embodiment and those in FIG. 10 and FIG. 11 used in the second embodiment either as the centralized control type or as the decentralized control type.

As described in detail in the above embodiments, it is possible, by using the present invention, to configure the network freely mixing the low order and high order paths. To be more specific, it is possible, even in the case where there is only a low demand compared to the bandwidth of the high order path between two nodes and so the bandwidth becomes redundant even when the high order path is set by the past technology, to aggregate a plurality of low order paths having different starting point and endpoint nodes so as to set the high order path and effectively use the bandwidth of the high order path. It is possible to reduce required node resources by setting the high order path.

In addition, it is possible, by using the present invention, to dynamically set the high order path in an arbitrary place in the communication network where the hierarchical paths exist.

What is claimed is:

1. A communication network including a plurality of nodes and a plurality of link groups connecting these nodes, wherein said nodes include:
a first node having a switch for switching a path having a predetermined bandwidth (hereafter, referred to as a low order path); and
a second node having a switch for switching said low order path, a switch for switching a path having a bandwidth larger than said predetermined bandwidth (hereafter, referred to as a high order path), multiplexing means of multiplexing N (N is an integer of 2 or more) of said low order paths on one of said high order paths, and separating means of separating one of said high order paths into N of said low order paths, and
said low order path is set between any two of said nodes and said high order path is set between any two of said second nodes.

2. The communication network according to claim 1, wherein all said nodes are said second nodes.

3. The communication network according to claim 1, wherein a centralized control unit capable of communication with all said nodes and having a path table recording route information on all said existing low order paths is provided, and said centralized control unit set actively said low order path and said high order path.

4. The communication network according to claim 1, wherein every said node has a node control unit having a path table recording route information on all the low order paths passing that node, and said low order path and said high order path are set actively by said node control unit.

5. The communication network according to claim 1, wherein said low order path is a wavelength path and said high order path is a wavelength group path.

6. The communication network according to claim 1, wherein said low order path is a wavelength path and said high order path is an optical fiber path.

7. The communication network according to claim 1, wherein said low order path is a wavelength group path and said high order path is an optical fiber path.

8. A path setting method in a communication network including:
a node having a switch for switching a path having a predetermined bandwidth (hereafter, referred to as a low order path);
a node having a switch for switching said low order path, a switch for switching a path having a bandwidth larger than said predetermined bandwidth (hereafter, referred to as a high order path), multiplexing means of multiplexing N (N is an integer of 2 or more) of said low order paths on one of said high order paths, and separating means of separating one of said high order paths into N of said low order paths; and
a plurality of link groups connecting these nodes, wherein:
in the case where N (N is an integer of 2 or more) of said low order paths having a route partly coinciding with a section connecting any two of said high order paths exist, the high order path on which the N of said low order paths are multiplexed is set in said section.

9. A path setting method in a communication network including:
a first node having a switch for switching a path having a predetermined bandwidth (hereafter, referred to as a low order path);
a second node having a switch for switching said low order path, a switch for switching a path having a bandwidth larger than said predetermined bandwidth (hereafter, referred to as a high order path), multiplexing means of multiplexing N (N is an integer of 2 or more) of said low order paths on one of said high order paths, and separating means of separating one of said high order paths into N of said low order paths; and
a plurality of link groups connecting these nodes, wherein:
on a route of a first low order path having any two of said first node or said second node as its starting point node and endpoint node, attention is paid to a section that is a part of said route in predetermined order, and if the second to N-th (N is an integer of 2 or more) low order paths of which route partly coincides with said section exist, the high order path on which the first to N-th low order paths are multiplexed is set in said section.

10. The path setting method according to claim 9, wherein, if length of the route of said first low order path is L, attention is paid first to a section that is entirety of said route, and then to all the sections of which length is L-1, and thereafter to all the sections of which length is L-2, L-3, . . . , 2 in order.

11. The path setting method according to claim 9, wherein, if length of the route of said first low order path is L, attention is paid first to the sections having as one terminal point a starting point node of said first low order path of which length is L, L-1, L-2, . . . , 2, and then to the sections having as one terminal point the node on an endpoint node side by 1 hops from said starting point node of which length is L-1, L-2, L-3, . . . , 2, and thereafter to the sections having as one terminal point the node on the endpoint node side by I hops from said starting point node of which length is L-I, L-I-1, L-I-2, . . . , 2 in order of I=2, 3, 4 . . . , L-2.

12. A node apparatus in a communication network including:
a switch for switching a path having a predetermined bandwidth (hereafter, referred to as a low order path);
a switch for switching a path having a bandwidth larger than said predetermined bandwidth (hereafter, referred to as a high order path);
multiplexing means of multiplexing N (N is an integer of 2 or more) of said low order paths on one of said high order paths;
separating means of separating one of said high order paths into N of said low order paths; and
node controlling means having a path table recording route information on all the low order paths passing that node, and wherein:
said low order path and said high order path are set by said node controlling means.
